(19) United States
(12) Patent Application Publication
(10) Pub. No.: US 2019/0260202 A1
(43) Pub. Date: Aug. 22, 2019

(54) Superconducting Current Limiter

(71) Applicant: Siemens Aktiengesellschaft, Muenchen (DE)

(72) Inventors: Joachim HOFFMANN, Burgthann (DE); Jörn GRUNDMANN, Großenseebach (DE); Christian SCHACHERER, Deining (DE)

(21) Appl. No.: 16/333,652

(22) PCT Filed: Jul. 17, 2017
(86) PCT No.: PCT/EP2017/068010

§ 371 Date: Mar. 15, 2019

(30) Foreign Application Priority Data
Sep. 15, 2016 (DE) 10 2016 217 671.4

(51) Int. Cl. H02H 9/02; B63H 21/17; H01F 6/06; H01F 6/04

(52) U.S. Cl. CPC H02H 9/023; B63H 21/17; B63H 2021/173; H01F 6/04; H01F 6/06

(57) ABSTRACT

A superconducting current limiter with a bifilar coil winding made of a T_{c} superconductor (HTS) conductor in a cryostat that includes a solid filler material, where the solid filling material is particularly formed from a granulate, hollow bodies or an open-pored structure and is surrounded by cryogen.

### CROSS-REFERENCE TO RELATED APPLICATIONS

This is a U.S. national stage of application No. PCT/EP2017/068010 filed Jul. 17, 2017. Priority is claimed on German Application No. DE102016217671.4 filed Sep. 15, 2016, the entire content of which is incorporated herein by reference in its entirety.

### BACKGROUND OF THE INVENTION

### 1. Field of the Invention

The invention relates to a superconducting current limiter, which is particularly intended to limit a fault current, and where the current limiter has an HTS conductor which can be cooled by a coolant.

### 2. Description of the Related Art

DE 10 2004 048 646 A1 or DE 10 2006 032 702 B3 disclose conventional current limiter devices.

Since superconducting connections, such as metal oxide connections with high critical temperatures T_{c} of above 77 K, have become known, which are therefore also known as high T_{c} superconductor materials or HTS materials and in particular allow a liquid nitrogen (LN₂) cooling, attempts have been made to also design superconducting current limiting devices with corresponding HTS conductors. Such a current limiting device can be found in the aforementioned DE 10 2004 048 646 A1 document. It is constructed with a least one HTS tape conductor, in particular a tape-like RABiTS conductor, which has a metallic, textured carrier tape, in particular a “RABiTS tape”, made of an Ni alloy. Deposited on this carrier tape is a coating system of oxidized buffer materials, such as CeO₂ or Y₂O₃ and the HTS material, especially of YBA₂Cu₃Oₓ (“YBCO”). This structure is also covered by a thin, normally-conducting cover coating, in order to suppress “hot spots” (cf. also DE 198 36 860 A1 here), where additionally measures are also taken to avoid electrical flashovers between the cover coating and the metallic substrate. A corresponding conductor type is also referred to as a “coated conductor”. In the known current limiting device a spiral-shaped bifilar coil winding with good accessibility for the coolant LN₂ is wound from such an HTS tape conductor. In a current limiting device, the HTS conductor track can also be formed on an expanding substrate board made of sapphire and can feature an Au cover coating.

Superconducting fault current limiters (SFCL) are preferably cooled with a cryogenic liquid (as a rule with liquid nitrogen=LN₂). In such cases, the cryogen takes on almost the entire heat load that is handled in an FCL. It evaporates through this, whereby the pressure in the cryostat increases in a function-related manner. The operation of the SFCL can be simplified if less cryogen is used. When fault situations are being considered attention should be paid to safety aspects, e.g., faults in the thermal insulation (for example, collapse of the insulation vacuum of the cryostat), or igniting of an interference arc in the cryostat. These are cases in which almost at a stroke a very high amount of heat enters the cryogen. Correspondingly, the layout of the cryostat is to be adapted accordingly. For example, a layout of the cryostat can take account of a high pressure (e.g., >5 bar). Over and above this further safety precautions can be taken, such as with respect to the pressure container arrangement, safety valves, rupture disks etc. The factor for the change in volume of LN₂ to nitrogen gas under normal conditions amounts to around 650.

### SUMMARY OF THE INVENTION

An object of the present invention is to improve a superconducting current limiter.

This and other objects and advantages are achieved in accordance with the invention by a superconducting current limiter that has a coil winding made of an HTS conductor in a cryostat, where the cryostat has a solid filler material, which in particular surrounds the coil winding. The cryostat also has a cryogen. The cryogen is LN₂, for example. The filler material is in particular enclosed by the cryogen.

The solid filler material makes it possible to reduce the volume of cryogen. The cryogen volume is reduced by comparison with a superconducting current limiter without solid filler material in the cryostat. It is further possible through the solid filler material to reduce the heat emitted into the cryogen.

The filler material is a granulate, for example. Granulate has a plurality of particles, such as grains and/or spheres.

The particles of the same or different material or of the same or different size are to be selected, for example, so that there is sufficient volume available between the particles for LN₂, in order to be able to continue to fulfill the task of cryogenic cooling. This can be achieved, for example, by a suitable choice of grain size or by a mixture of different grain sizes. The shape of the grains can likewise play a part.

The requirements for the material properties of the chosen filler material are, for example, at least one or a plurality of the following requirements:
Electrically-insulating material in all states (initial state solid, liquid, hardened) and at all temperatures;
Permittivity as close as possible to that of LN₂ (appr. 1.44); The permittivity can lie between one and four, preferably between one and three. This can serve, for example, so that, for reasons of electrical insulation, the distance from the cryostat wall to the active part does not have to be increased;
High thermal storage capacity at operating temperature; these are values greater than 100 J/(kg*K), preferably greater than 200 J(kg*K);
High melting heat; for example, greater than 80 J/g;
High thermal conductivity; this is of particular significance with a coarse grain size; at operating temperature the thermal conductivity is greater than 0.1 W/(m*K), for example, in particular greater than 0.3 W/(m*K).

Through the filler material, it is possible to effectively limit the increase in pressure in the superconducting current limiter when heat is emitted and/or at least to delay it in time. Through the filler material used in the FCL, the cryostat is no longer only or completely filled with LN₂, but also with the granulate and additionally a proportion of LN₂. This also enables a reduced and/or delayed increase in pressure during the FCL response to be achieved. In the event of a fault, a simplification or improvement of the system parameters by reduced requirements on the cryostat and the safety systems can be produced by the filler material. The volume of cryogen in the superconducting current limiter is reduced by the filler material. The filler material can also result in improved arc extinction characteristics in the event of a fault. This applies in particular to DC applications, in order where necessary just to obtain any possibility at all of an arc extinction. A low-cost material can be used as the filler material, which leads to a simple and/or low-cost implementation capability for its production.

In one embodiment of the superconducting current limiter, the filler material is a granulate and/or an open-pored structure. The filler material thus consists of granulate and/or an open-pored structure, or the filler material has a granulate structure or an open-pored structure. In one embodiment of the open-pored structure, this is designed as foam. The foam features polyurethane (PUR), for example, or is structured on the basis thereof. Even with open-pored foam a high fill factor is advantageous, in order to enable the volume of cryogen needed to be kept low. A foam made of PUR can be designed porous, is easy to introduce into a cryostat and is easily able to be soaked with cryogen.

In one embodiment of the superconducting current limiter, the filler material surrounds the coil winding. In this embodiment, the filler material is between the coil winding and the inner wall of cryostat. In this way, the insulating characteristic of the filler material can be used.

In one embodiment of the superconducting current limiter, the filler material is surrounded by cryogen. The filler material can be entirely or partly surrounded by cryogen. This depends, for example, on whether the cryogen level is above that of the filler material.

In one embodiment of the superconducting current limiter, the limiter is operated supercooled. In this case, the cooling head projects into the LN₂. In this case too the advantages of the filler material can be used.

In another embodiment of the superconducting current limiter, the filler material is a mixture of materials. The filler material can thus consist of one material, or can feature different materials.

In one embodiment of the superconducting current limiter, the filler material features sand, gravel, plastic, glass, quartz, quartz glass, epoxy, ceramic and/or soapstones.

In one embodiment of the superconducting current limiter, the inner cryostat volume is filled entirely or partly with a bulk material, such as sand, gravel, granulate. When sand is used the switch-off capability in the event of the ignition of an arc can be improved. By comparison, with an arc in air, for example, a significantly more intensive cooling is achieved by the sand, on the one hand by the greater contact surface between the arc and the grains of sand, but above all as the event progresses by the melting of the sand. The intensive cooling makes a renewed ignition, especially after a zero crossing, more difficult, or increases the burning voltage so far that the current in the arc can no longer be maintained by the driving voltage and the arc is thereby extinguished (relevant for, e.g., DC applications). A non-conductive sinter body is produced thereby in the area of influence of the arc. It is to be avoided that the liquid melt or the hot sinter body hardening again is electrically conductive.

A further thermal capacity, in addition to the LN₂, is made available by the filler material, which can accept thermal energy during operation (limiting) or in the event of a fault and in doing so does not contribute to an increase in pressure or contributes to it to a far lesser degree than evaporating LN₂.

Since the filler material, which in particular is generally a bulk material, is operated in a nitrogen atmosphere (hardly any oxygen) when LN₂ is used, as well as the sand mentioned, a wider choice of material comes into consideration. Plastics can also be chosen. Thermoplastics (e.g., PE, PVC (hard), PTFE, PEEK etc.) are of particular interest: The permittivity is relatively low for a plastic (2 . . . 2.5), likewise the melting temperature. Moreover, thermoplastic granulates are a preliminary product for different industries and are therefore available in large volumes and at relatively low cost. However, despite their frequently higher permittivity, filled duroplastics (e.g., filled epoxy resin (EP)) can also be considered, because, with the choice of the correct filler material, by comparison with thermoplastics, a high volume-related heat storage capacity, as well as a relatively low thermal conductivity, can be achieved. If EP is used for filling, then a proportion of SiO₂ will be present as a filling in the resin. The filling enables the thermal conductivity to be increased by comparison with pure resin, at the same time the density as well (and thus the thermal capacity per volume). The coefficient of thermal expansion is reduced. This is good, because in this way less cryogen is needed. Inorganic insulators, such as glass, quartz, ceramic and/or soapstones, can also be used, despite their high resistance to arcs and their high permittivity.

In a further embodiment of the superconducting current limiter, the filler material has different grain sizes. Different grain sizes enable the density of the filler material to be influenced and thus the volume of cryogen with which the limiter is filled.

In yet a further embodiment of the superconducting current limiter, the grain size of the filler material is chosen so that it is coarse enough that no filler material can get into a critical area for cooling, i.e., in particular within the coil stack.

In another embodiment of the superconducting current limiter, the cryogen level exceeds the height of the filler material. In this way, the surface for evaporation of the cryogen can be kept large.

In a still further embodiment of the superconducting current limiter, a first barrier separates the coil winding from the filler material. The barrier is a grating structure or a sieve structure, for example, which insulates electrically.

In a further embodiment, the coil stack is surrounded by a sieve and/or grating made from insulating material that, with an appropriately selected mesh size, prevents the filler material from entering. Thus, the coils continue to be exclusively surrounded by LN₂, which insures an effective cooling. Only the remaining volume in the cryostat is thus filled by a filler material.

In another embodiment of the superconducting current limiter, the limiter has a second barrier. The second barrier separates a cooling head from the filler material. In a closed system cooled with a cooling head (or refrigerator), the cooling head can thus likewise be surrounded by a grating/sieve, so as to keep the available surface free for condensation of nitrogen gas. As an option, the filling with bulk material can also end below the cooling head.

In another embodiment of the superconducting current limiter, the filler material has hollow bodies, which in particular are filled with nitrogen. For example, the filler material is produced in a vacuum as hollow bodies (for example, as a sphere) or filled retroactively in a nitrogen atmosphere (if necessary even under slight pressure) with pure nitrogen and sealed. In the superconducting current limiter, the nitrogen in this hollow body will be evaporated during cooling down (putting into operation), a significant vacuum is produced. In this case, attention should be paid to sufficient sealing and wall strength (no appreciable deformation in the cold state). Since the superconducting current limiter is operated as a rule at a very much higher pressure (usually 1 to 5 bar) than the filling of the hollow bodies has, in the event of the enclosure being melted by an arc, the increase in pressure is reduced very effectively by the volume with a vacuum that opens. Aspects of electrical insulation are again to be taken into account for this special case in the layout (inter alia the Paschen curve).

In a method for transporting a superconducting current limiter with a coil winding made of an HTS conductor, a cryostat with a filler material is used. Examples of this are described above. The filler material produces an improved ability for the superconducting current limiter to be transported, e.g., from the manufacturing location to the usage location. The entire inner workings (active power supply, sensors etc.) of the superconducting current limiter are fastened to the cover, above all for installation reasons, with a cross sectional surface of the fastenings that is as small as possible with a length to the LN₂ that is as large as possible. A reason for this is the thermal conductivity. This pattern is very unstable and susceptible to vibration and shocks, unless damping is provided by the LN₂. On the transport route, however, the superconducting current limiter is not filled with LN₂. Therefore, without any filler, a plurality of transport locks is necessary as a rule. The filler material enables the transport locks either to be dispensed with or their number to be reduced.

In one embodiment of the method for transport of the superconducting current limiter, the filler material is put/placed into the cryostat after the winding of the coil.

The superconducting current limiter is operated in one embodiment of operation at an operating temperature or around 77 Kelvin, which is what its superconducting part demands.

A watercraft has a superconducting current limiter. The superconducting current limiter has a filler material, as is described above and below. The watercraft is an example of a mobile application. The superconducting current limiter with filler material is suitable for mobile applications, such as in particular in a ship, because the sloshing about of the cryogen can be greatly reduced by the filler material.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further embodiments of the inventive current limiter emerge from the examples given in the figures explained below, in which:

FIG. 1 shows a superconducting current limiter in accordance with the invention;

FIG. 2 shows a bifilar wound coil in accordance with the invention;

FIG. 3 shows a perspective diagram of bifilar wound coils consisting of HTS tape conductors in a parallel and serial circuit in accordance with the invention;

FIG. 4 shows a superconducting current limiter with a cryogen level above the height of the filler material in accordance with the invention;

FIG. 5 shows a superconducting current limiter with a large-grain filler material in accordance with the invention; and

FIG. 6 shows a watercraft with a superconducting current limiter.

### DETAILED DESCRIPTION OF THE EXEMPLARY EMBODIMENTS

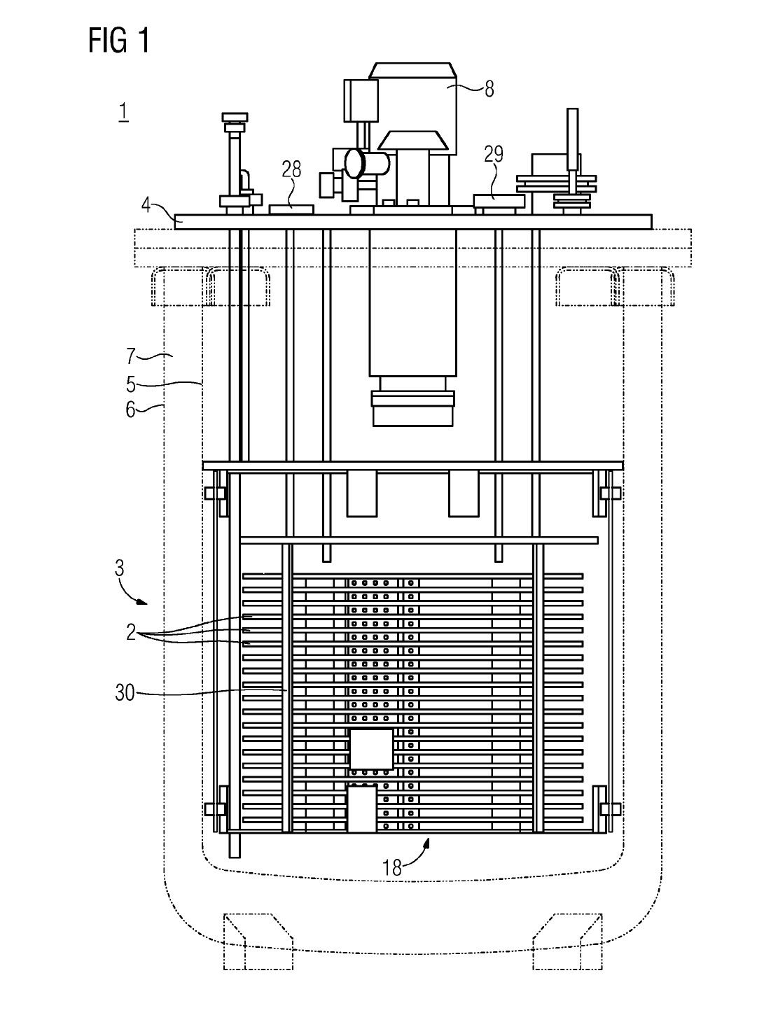

The diagram depicted in FIG. 1 shows a superconducting current limiter 1 with a coil winding 2 made of a High T_{c} Superconductor Material (HTS) conductor in a cryostat 3. The solid filler material located in the cryostat 3 is not shown in FIG. 1. The cryostat 3 has a cryostat inner wall 5, a cryostat outer wall 6, a vacuum 7 lying between the walls and a cryostat cover 4. A cooling head 8 sits in the cryostat cover 4.

The cryostat 3 (double-walled “tub” with insulating vacuum) is closed off with the cryostat cover 4. The cryostat cover 4 has break-throughs for power, measuring systems and cooling, for example. The cooling head 8 is that of a refrigerator, for example. The cryostat cover has safety devices, such as a rupture disk 28 and/or an excess pressure valve 29. A plurality of coil windings forms the active part 18 of the superconducting current limiter 1. The active part 18 has rods 30 with low thermal conductivity, e.g., GRP, as thin and as long as possible down to the LN₂ level above which it is suspended. The cryostat 3 is filled entirely or partly with LN₂. The layout can, in some cases, be overpressurized or underpressurized or undercooled in relation to the LN₂, depending on boundary conditions. Open systems should also be considered, in which the cryogen 14 can evaporate and which are refilled on a regular basis.

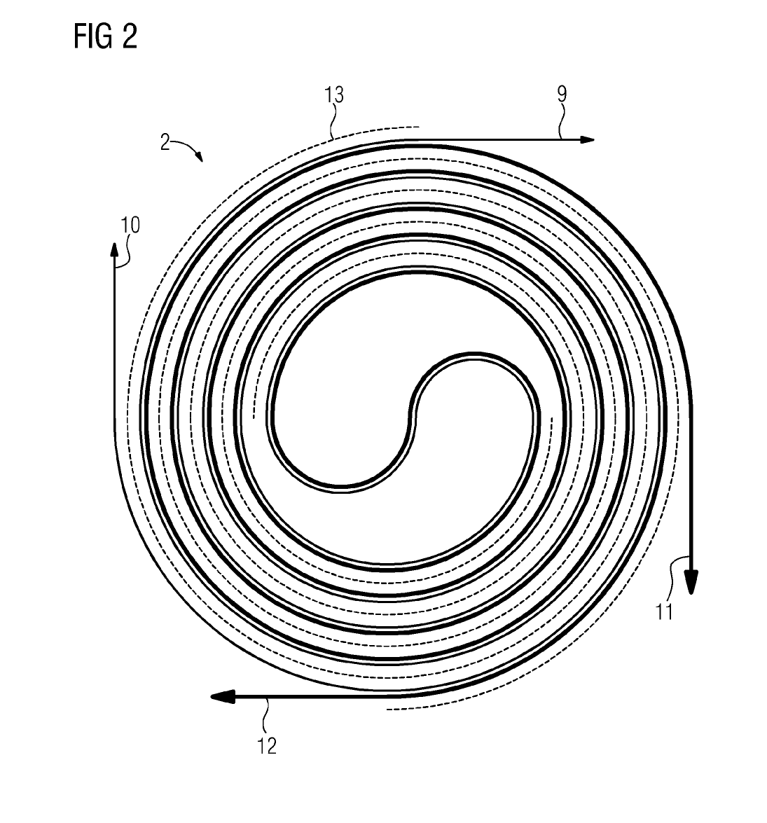

The active part 18 has superconducting tape conductors, such as (second-generation high-temperature superconductors, e.g., YBCO HTS tape conductors) which are processed into bifilar wound coils. In such cases, the windings of the coils are held at a distance from each other by spacers, also called distance pieces 13 (see FIG. 2), in order to be able to wet the surface of the tape conductors completely with LN₂.

The superconducting current limiter 1 limits the current in the event of a short circuit by the transition from the superconducting state into the normal state (triggering by the increased current in the case of a short circuit>critical current of the HTS tape conductors; complete limiting by heating up to T>critical temperature T_{c}). The volume of heat introduced by the quench into the tape conductors must be emitted again as soon as possible to the LN₂, so that the superconducting current limiter is quickly ready for operation again. The increase in pressure occurring in such cases (by the evaporation of the LN₂) is small because of the relatively small amount of heat (current is limited) and, like the heat input, can be removed again without any problems from the environment (power feed, cryostat walls etc.) over time by the cooling head 8 by condensation of nitrogen gas N₂. The bifilar wound coils 2 are combined into one or more stacks and switched in parallel and/or in series according to the rated voltage and the rated current.

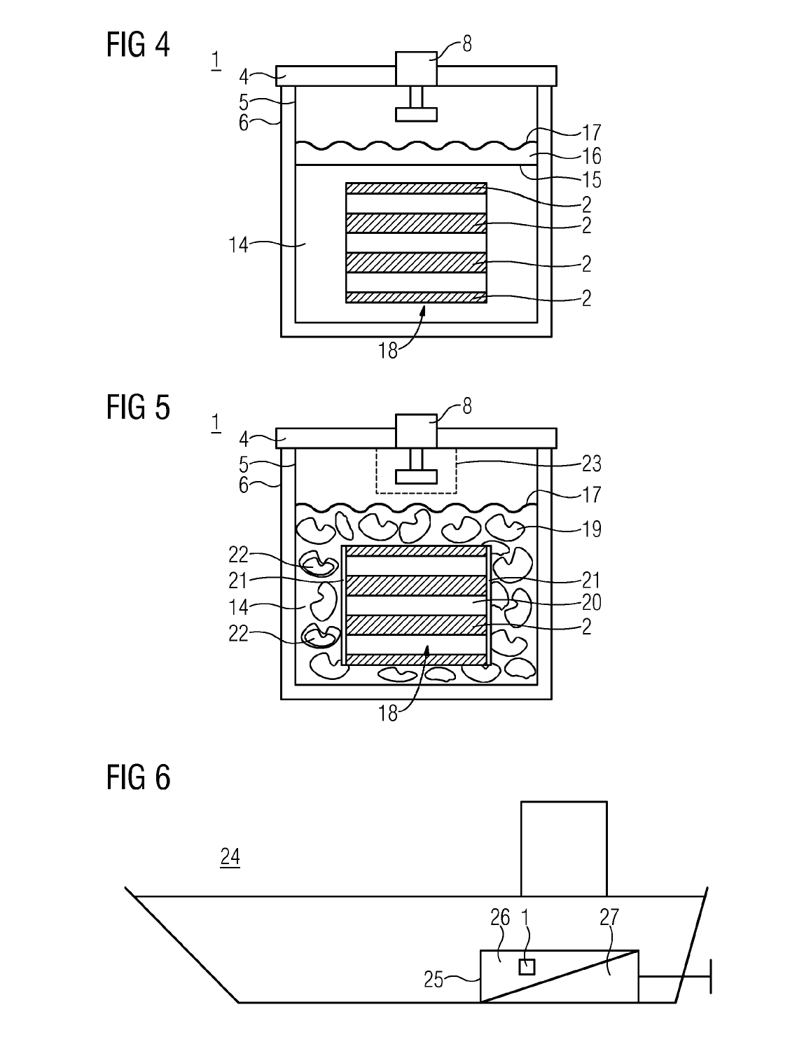

The fault case considerations are also decisive for the dimensioning, specification and also the costs of the cryostat 3. A sudden increase in the heat input means that the pressure increases rapidly and would lead in the end to an enormously high pressure in the cryostat 3, which can no longer be managed at reasonable expense. Possible safety measures to be taken are: Excess pressure valves, rupture disks, designing the cryostat for several bars while taking into account the pressure container arrangement, e.g., larger cryostat etc. Without filler material, almost the entire thermal energy will be converted into the evaporation of the LN₂. Complexity and costs of the protective measures are determined by the speed of the increase in pressure (as a consequence of the power of the heat source) and by the thermal energy converted overall. The igniting of an interruption arc in the inside of the cryostat 3 is to be seen as critical, in this context. If an interruption arc ignites (e.g., through double faults from a combination of short circuit and lightning strike or similar scenarios), then in the worst case the power of the full short-circuit current without superconducting current limiter (unlimited short-circuit current) can be thermally converted at full rated current. The filler material counteracts this here. The filler material (see FIG. 4 or FIG. 5) improves the thermal behavior in a positive way.

The diagram depicted in FIG. 2 shows a bifilar wound coil 2 with a first plus conductor 9, with a first minus conductor 10, with a second plus conductor 11 and a second minus conductor 12. A spacer 13 (distance piece) is provided for the separation of conductors.

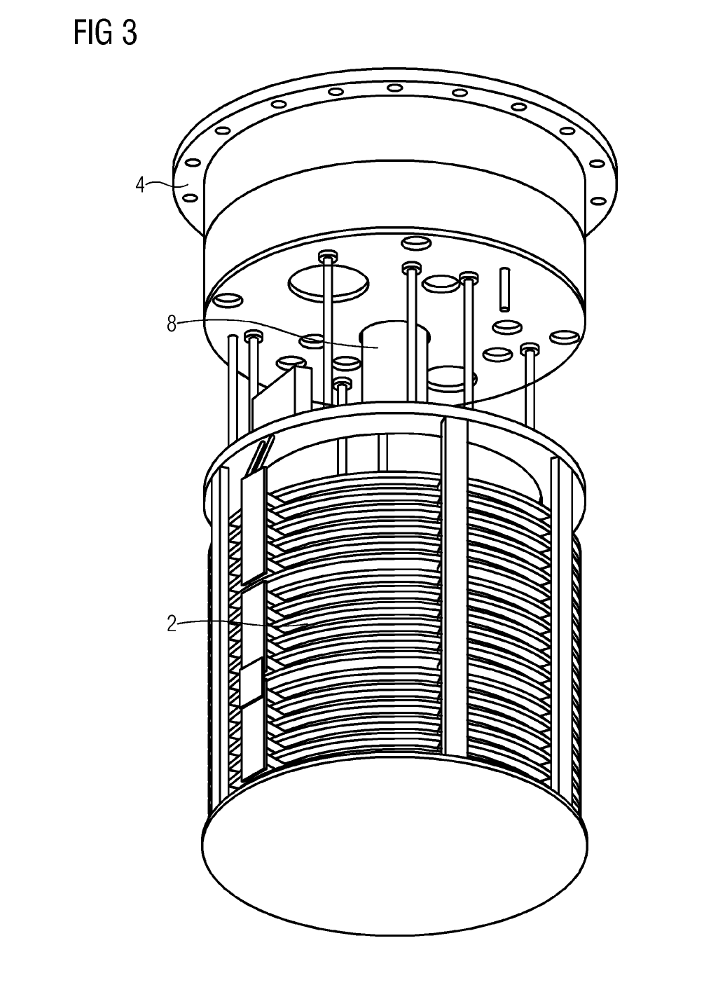

The diagram depicted in FIG. 3 shows a perspective diagram of bifilar wound coils 2 made of HTS tape conductors in a parallel and series circuit with the cryostat cover 4, into which the cooling head 8 is integrated.

The diagram depicted in FIG. 4 shows a superconducting current limiter 1 in a further schematicized form, which is filled with a cryogen 16 and a filler material 14. The height 15 of the filler material 14 is lower than the level 17 of the cryogen 16. The coil windings 2 form an active part 18, which is positioned entirely in the filler material 14 and in the cryogen 16. The cooling head 8 is above the level 17 of the cryogen. Consequently, the cryostat 3 here is only partly filled and the level of the LN₂ is above the limit of the filler material (bulk material limit) 15.

The diagram depicted in FIG. 5 shows a superconducting current limiter 1 in a further schematicized form, which has coarse-grain filler material 19. In particular, the limiter also has filler material 19 with hollow bodies 22.

The grain size of the filler material 19 is selected to be coarse enough not to get into a critical area for the cooling, i.e., particularly within the coil stack of the active part 18. This relates in particular to the spaces 20 into which only LN₂ gets.

So that no filler material 19 gets into the active part, a first barrier 21 is also provided, which separates the coil windings 2 from the filler material 19. Furthermore, a second barrier 23 is provided, so that no filler material 19 reaches the cooling head 8 and the cooling head is separated in this way from the filler material 19.

The diagram depicted in FIG. 6 shows a watercraft 24 (a ship according to FIG. 6, where the watercraft can also be a submarine), which has a drive unit 25. The drive unit 25 has an electric part 26 and a mechanical part 27. The superconducting current limiter 1 is provided to protect the electric part 26, with, e.g., a motor, a generator, a current converter etc. The mechanical part 27 has a diesel engine or a transmission, for example.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A superconducting current limiter with a coil winding consisting of a T_{c} superconductor (HTS) conductor in a cryostat, wherein the cryostat has a solid filler material.

17. The superconducting current limiter as claimed in claim 16, wherein the solid filler material is surrounded by cryogen.

18. The superconducting current limiter as claimed in claim 16, wherein the solid filler material is a mixture of materials.

19. The superconducting current limiter as claimed in claim 16, wherein the solid filler material features at least one of sand, gravel, plastic, glass, quartz, ceramic and soapstones.

20. The superconducting current limiter as claimed in claim 16, wherein the solid filler material has different grain sizes.

21. The superconducting current limiter as claimed in claim 16, wherein the cryogen level exceeds a height of the solid filler material.

22. The superconducting current limiter as claimed in claim 16, wherein a first barrier separates the coil winding from the solid filler material.

23. The superconducting current limiter as claimed in claim 16, wherein a second barrier separates a cooling head from the solid filler material.

24. The superconducting current limiter as claimed in claim 16, wherein the filler material features nitrogen filled hollow bodies.

25. The superconducting current limiter as claimed in claim 16, wherein the solid filler material is one of a granulate and an open-pored structure.

26. The superconducting current limiter as claimed in claim 25, wherein the open-pored structure is foamed.

27. A method for transporting a superconducting current limiter with a coil winding consisting of a T_{c} superconductor (HTS) conductor, wherein a cryostat is utilized with a solid filler material.

28. The method for transporting a superconducting current limiter as claimed in claim 27, wherein a superconducting current limiter with a coil winding consisting of a T_{c} superconductor (HTS) conductor in a cryostat is utilized, and wherein the cryostat has a solid filler material.

29. The method for transporting a superconducting current limiter as claimed in claim 27, wherein the solid filler material is placed into the cryostat after the coil winding.

30. A watercraft, which has a superconducting current limiter with a coil winding consisting of a T_{c} superconductor (HTS) conductor in a cryostat, wherein the cryostat has a solid filler material.

31. The method for transporting a superconducting current limiter as claimed in claim 28, wherein the solid filler material is placed into the cryostat after the coil winding.

32. The superconducting current limiter as claimed in claim 17, wherein the solid filler material is a mixture of materials.
